(19) United States
(12) Patent Application Publication
(10) Pub. No.: US 2015/0172773 A1
(43) Pub. Date: Jun. 18, 2015

(54) SYSTEMS AND METHODS FOR SELECTIVELY PRINTING THREE-DIMENSIONAL OBJECTS WITHIN MEDIA ASSETS

(71) Applicant: United Video Properties, Inc., Santa Clara, CA (US)

(72) Inventors: Walter R. Klappert, Los Angeles, CA (US); Marvin Charles Carlberg, Los Angeles, CA (US); Michael B. Case, Sherman Oaks, CA (US); Michael K. McCarty, Agoura Hills, CA (US); Jeffrey Neil Berenson, Nashua, NH (US); Raymond Valadez, JR., Walnut, CA (US)

(73) Assignee: UNITED VIDEO PROPERTIES, INC., Santa Clara, CA (US)

(21) Appl. No.: 14/133,125

(22) Filed: Dec. 18, 2013

(51) Int. Cl. H04N 21/478; G06F 3/0484; H04N 21/431; B29C 67/00; H04N 21/258; H04N 21/45; H04N 21/81; H04N 21/41; G06Q 30/06; H04N 21/466

(52) U.S. Cl. CPC H04N 21/47815; G06Q 30/0643; G06F 3/04842; G06F 3/04845; G06Q 30/0621; G06Q 30/0631; H04N 21/4312; H04N 21/4668; H04N 21/25891; H04N 21/4532; H04N 21/816; H04N 21/8146; H04N 21/4117; B29C 67/0051

(57) ABSTRACT

Methods and systems are provided herein for recommending an object of a plurality of objects for 3D printing. These methods and systems are provided by way of identifying a set of objects presented within a video being viewed by a viewer. One object of the set of objects may be selected based on a user profile. For example, in a scene where a coffee mug and a toy figurine are presented, and the user watching the video including the scene is a child, the toy figurine might be selected because the child's user profile may reflect an affinity for toys, or because the child is too young to drink coffee. A design file describing a three-dimensional representation of the object might be retrieved, and a request may be transmitted to a printer to print the three-dimensional representation of the object.

### BACKGROUND

Three-dimensional (3D) printing is an emerging technology that enables a user to “print” a 3D object based on an associated design file. For example, rather than purchase a mug from a store, a user may use a 3D printer to print a desired mug design. Today's 3D printers are cumbersome to use because a user must take the time and effort involved in not only choosing a design of a desired object, but also ensuring that design is viable given a user's cost constraints, and compatible with the user's 3D printer and its capabilities.

### SUMMARY

Methods and systems are provided herein for recommending an object of a plurality of objects for three-dimensional printing. These methods and systems are provided by way of identifying a set of objects presented within a video being viewed by a viewer (e.g., a coffee mug or toy figurine). One of the objects may be selected based on a user profile. For example, in a scene where a coffee mug and a toy figurine are presented, and the user watching the video including the scene is a child, the toy figurine might be selected because the child's user profile may reflect an affinity for toys, or because the child is too young to drink coffee. A design file describing a three-dimensional representation of the object is then retrieved, and a request may be transmitted to a printer to print the three-dimensional representation of the object. For example, if the toy figurine is selected, a design file reflecting 3D print specifications of the toy figurine is retrieved and utilized by the printer to print a representation of the toy figurine.

In some embodiments, user characteristics associated with the user profile are identified. For example, a user characteristic may be a genre of media a user prefers, a demographic associated with a user, or cost parameters specified by a user. It may be determined which object of a set of objects in a video frame has a greatest number of object characteristics that match user characteristics associated with the user profile. For example, if a user is determined to enjoy jewelry, but has a small budget, a silver jewelry object may be the determined object instead of a potential gold jewelry object. The determined object may be designated as the selected object for which a file is retrieved for printing a representation of the object.

In some embodiments, the user profile may include at least one of a printing history, printing preferences, and demographic information. The selected object may be selected by comparing metadata associated with each object with metadata of the user profile. For example, if a user has a history of printing toys, and an object in a video frame has metadata that reflects the object is a toy, the toy may be the object selected for printing.

In some embodiments, the retrieved design file may be selected based on a cost associated with printing the three-dimensional object described by the retrieved design file. In some embodiments, the cost associated with printing the three-dimensional object described by the retrieved design file may be associated with the cost of materials required to print the three-dimensional representation of the object. For example, if a frying pan is an object in a video frame, and different design files associated with the frying pan reflect materials of escalating cost, such as a Teflon pan versus a cast iron pan versus a plastic frying pan replica, the cost of each may be considered as a factor in the selection of an object.

In some embodiments, a display may be generated of the three-dimensional representation of the object. For example, a design file for a coffee mug may be accessed, where a three-dimensional representation of the coffee mug is specified by the design file. The specified three-dimensional representation may be reflected in the generated display. User input may be received to configure the three-dimensional representation of the object. For example, the user input may designate a color or a logo for the coffee mug. A new request may be transmitted to the printer to print the configured three-dimensional representation of the object. For example, a coffee mug with a user specified logo and color may be printed instead of the coffee mug specified by the design file.

In some embodiments, a display is generated including a user interface that provides tools to modify the three-dimensional representation of the object, wherein the user input is received via the user interface. For example, the user interface may enable a user to change facial features of a figurine. In some embodiments, the three-dimensional representation of the object may be modified in response to receiving user input by, e.g., adjusting a pose of a three-dimensional representation of an object or adding a prop to the three-dimensional representation of the object or deleting a feature from the three-dimensional representation of the object. For example, a three-dimensional representation of a knight figurine may be modified by the addition of a sword, or may be modified to a “fighting” pose rather than a “relaxed” pose.

In some embodiments, a print request may be transmitted to a remote server that is remote to the user equipment, where a printer to which the request is directed is located at the network that is remote to the user equipment. In some embodiments, the printer may be located at a local network that the user equipment is located at. For example, an object may be selected for printing at a user's own home, or at a remote printing site.

In some embodiments, edible food is printed by the printer. For example, a user may be viewing a video about a certain food. That food may be printed by a 3D printer.

Methods and systems are also provided herein for delivering an appropriate design file for printing of a three-dimensional object. These methods and systems are provided by determining a printer capability associated with user equipment. The determined printer capability may be, for example, the capabilities of a printer that is operatively linked with the user equipment. The determined printer capability may also or alternatively correspond to, for example, one or more entries in a user profile. In particular, a selection of an object in a video may be received at the user equipment (e.g., a frying pan in a video about food). A set of design files associated with that object is identified, where each design file describes a three-dimensional representation of the object. For example, the set of design files for the above-mentioned frying pan may specify the use of Teflon, or may specify the use of cast-iron. A design file from the set of design files may be selected based on the determined printer capability (e.g., if a printer that is operatively linked with the user equipment is not capable of printing Teflon, but is capable of printing an iron model, the cast-iron version of the frying pan may be selected). A request may be transmitted to the printer to print the three-dimensional representation of the object described by the selected design file.

In some embodiments, a display may be generated of the three-dimensional representation of the object. For example, a design file for a coffee mug may be accessed, and a three-dimensional representation of the coffee mug may be specified by the design file. The specified three-dimensional representation may be reflected in the generated display. User input may be received to configure the three-dimensional representation of the object. For example, the user input may designate a color or a logo for the coffee mug. A new request may be transmitted to the printer to print the configured three-dimensional representation of the object. For example, a coffee mug with a user specified logo and color may be printed instead of the coffee mug representation that was specified by the design file.

In some embodiments, a display may be generated including a user interface that provides tools to modify the three-dimensional representation of the object, wherein the user input is received via the user interface. For example, the user interface may enable a user to change facial features of a figurine. In some embodiments, the three-dimensional representation of the object may be modified in response to receiving user input by, e.g., adjusting a pose of a three-dimensional representation of an object or adding a prop to the three-dimensional representation of the object or deleting a feature from the three-dimensional representation of the object. For example, a three-dimensional representation of a knight figurine may be modified by the addition of a sword, or may be modified to a “fighting” pose rather than a “relaxed” pose.

In some embodiments, a required printing capability for each design file of the set of design files may be identified. For example, a design file may require the use of metal, plastic, or both. The identified required printing capability of each design file of the set of design files may be compared to the printing capability of the printer, and a design file may be selected based on a result of the comparing. For example, if a printer is only capable of printing plastic models, a design file of a figurine that only requires plastic may be selected to the exclusion of a design file of the figurine that requires both metal and plastic. In some embodiments, the printing capability may be associated with at least one of material, cost, size, and color, and the result of the comparison may be based on material, cost, size, or color that is specified by each design file.

In some embodiments, a print request may be transmitted to a remote server that is remote to the user equipment, where the printer is located at the network that is remote to the user equipment. In some embodiments, the printer may be located at a local network that the user equipment is located at. For example, an object may be selected for printing at a user's own home, or at a remote printing site.

In some embodiments, the user equipment may be a first user equipment that is portable, and a display may be generated including the video at second user equipment that is different from the first user equipment. For example, a movie may be played on a television screen, and the selection of an object in the movie may be selected at a tablet computer (e.g., iPad).

In some embodiments, a three-dimensional product is printed by the printer, and the product is edible food. For example, a user may be viewing a video about a certain food. That food may be printed by a 3D printer.

Methods and systems are also provided herein for sourcing a design file for three-dimensional printing of an object presented within a video. These methods and systems are provided by receiving a selection of an object, and generating a display including at least one of (1) a first selectable option to submit a design file describing a three-dimensional representation of the object, and (2) a second selectable option to access a design file describing a three-dimensional representation of the object submitted by another user. For example, if a selection of a frying pan is made, the user may choose to submit the user's own design file that specifies a three-dimensional representation of the frying pan. The user may also or alternatively choose to access a design file that specifies a three-dimensional representation of the frying pan that was submitted by another user. If the first selectable option is selected, the user's design file may be transmitted to a database for storage. If the second selectable option is selected, the design file that was submitted by another user (or previously submitted by the same user) may be retrieved from the database.

In some embodiments, when a selection of the second selectable option is received, a request is transmitted to a printer to print the three-dimensional representation of the object associated with the retrieved design file. For example, if the object is a frying pan, and the design file specifies a frying pan with a Teflon coating, a three-dimensional representation of the frying pan may be printed.

In some embodiments, a display may be generated of the three-dimensional representation of the object that is specified by the design file when the second selectable option is selected. For example, a three-dimensional representation of a coffee mug may be specified by the design file. The specified three-dimensional representation may be reflected in the generated display. User input may be received to configure the three-dimensional representation of the object. For example, the user input may designate a color or a logo for the coffee mug, or may add a photograph to the mug. Generally speaking, user input may include a submission of a photograph or image for inclusion on a three-dimensional object. In some embodiments, a design file that specifies the configured coffee mug may be stored at the database in response to the user selecting the first selectable option. In some embodiments, the user input may be made via a user interface that provides tools to modify the three-dimensional representation of the object, and the user may adjust a pose of or add a prop to the three-dimensional representation of the object or delete a feature from the three-dimensional representation of the object. For example, a three-dimensional representation of a knight figurine may be modified by the addition of a sword, or may be modified to a “fighting” pose rather than a “relaxed” pose.

In some embodiments, a three-dimensional product associated with the design file is printed by the printer, and the product is edible food. For example, a user may be viewing a video about a certain food. That food may be printed by a 3D printer. In some embodiments, the design file may comprise a recipe associated with the object.

In some embodiments, a display may be generated including a list of selectable objects. For example, if a video frame includes a beer mug, a toy dinosaur, a window, and a table, and design files are associated with the beer mug and the toy dinosaur, a list including the beer mug and the toy dinosaur and not including the window and the table may be generated for display. An object on the list may be selected for printing.

In some embodiments, the user equipment may be a first user equipment that is portable, and a display may be generated including the video at a second user equipment that is different from the first user equipment. For example, a movie may be played on a television screen, and the selection of an object in the movie may be selected at a tablet computer (e.g., iPad).

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative embodiment of a display screen that may be used to provide media guidance application listings and other media guidance information, in accordance with some embodiments of the disclosure;

FIG. 2 shows another illustrative embodiment of a display screen that may be used to provide media guidance application listings, in accordance with some embodiments of the disclosure;

FIG. 3 is a block diagram of an illustrative user equipment (UE) device in accordance with some embodiments of the disclosure;

FIG. 4 is a block diagram of an illustrative media system in accordance with some embodiments of the disclosure;

FIG. 5A shows an illustrative embodiment of a user equipment device that displays a video frame including selectable objects available for 3D printing, in accordance with some embodiments of the disclosure;

FIG. 5B shows an illustrative embodiment of a user equipment device that displays a video frame including selectable objects available for 3D printing, and reflects a user selection of objects, in accordance with some embodiments of the disclosure;

FIG. 6 shows an illustrative embodiment of user characteristics of a user profile, as well as objects in a video frame, in accordance with some embodiments of the disclosure;

FIG. 7 shows an illustrative embodiment of capabilities of a printer, in accordance with some embodiments of the disclosure;

FIG. 8 shows an illustrative embodiment of a user interface for configuring a three-dimensional representation of an object, in accordance with some embodiments of the disclosure;

FIG. 9 shows an illustrative embodiment of a first user equipment and a second user equipment device, where the second user equipment device displays selectable objects of a video frame presented at the first user equipment device, in accordance with some embodiments of the disclosure;

FIG. 10 shows an illustrative embodiment of a menu of selectable options that are presented in response to a user selection of an object, in accordance with some embodiments of the disclosure;

FIG. 11 is a flowchart of illustrative steps of a process for selecting an object of a video being viewed by a user, retrieving a design file describing a 3D representation of the object, and transmitting a request to print the 3D representation, in accordance with some embodiments of the disclosure;

FIG. 12 is a flowchart of illustrative steps of a process for identifying an object of a set of objects that shares the most characteristics associated with a user profile, in accordance with some embodiments of the disclosure;

FIG. 13 is a flow chart of illustrative steps of a process for receiving user input to configure a 3D representation of an object, and transmitting a request to print the configured 3D representation of the object, in accordance with some embodiments of the disclosure;

FIG. 14 is a flow chart of illustrative steps of a process for providing a user interface for modifying a 3D representation of an object, and either adjusting a pose of or adding a prop to the three-dimensional representation of the object, in accordance with some embodiments of the disclosure;

FIG. 15 is a flow chart of illustrative steps of a process for selecting a design file from a set of design files associated with an object in a video based on a printer capability associated with a user equipment, and transmitting a request to a printer to print a 3D representation of an object described by the selected design file, in accordance with some embodiments of the disclosure;

FIG. 16 is a flow chart of illustrative steps of a process for selecting a design file associated with an object based on the printing capabilities required by each design file of a set of design files, and based on the capabilities of a printer, in accordance with some embodiments of the invention;

FIG. 17 is a flow chart of illustrative steps of a process for allowing a user to contribute a design file associated with a selected object, or choose a user-contributed design file associated with the selected object, when a user wishes to print a 3D representation of the selected object, in accordance with some embodiments of the disclosure; and

FIG. 18 is a flow chart of illustrative steps of a process for transmitting a request to a printer to print a 3D representation of a selected object that is described by a selected user-submitted design file, in accordance with some embodiments of the disclosure.

### DETAILED DESCRIPTION OF EMBODIMENTS

Methods and systems are provided herein for recommending an object of a plurality of objects for three-dimensional printing. These methods and systems are provided by way of identifying a set of objects presented within a video being viewed by a viewer (e.g., a coffee mug or toy figurine). One object of the set of objects may be selected based on a user profile. For example, in a scene where a coffee mug and a toy figurine are presented, and the user watching the video including the scene is a child, the toy figurine might be selected because the child's user profile may reflect an affinity for toys, or simply based on the child's age. A design file describing a three-dimensional representation of the object might be retrieved, and a request may be transmitted to a printer to print the three-dimensional representation of the object. For example, if the toy figurine is selected, a design file including 3D print specifications of the toy figurine may be retrieved and utilized by the printer to print a representation of the toy figurine.

Methods and systems are also provided herein for delivering an appropriate design file for printing of a three-dimensional object. These methods and systems are provided by determining a printer capability associated with a user equipment. The determined printer capability may be, for example, the capabilities of a printer that is operatively linked with the user equipment or an entry in a user profile. A selection of an object in a video may be received at the user equipment (e.g., a frying pan in a video about food). A set of design files associated with the object may be identified, where each design file of the set of design files describes a three-dimensional representation of the object. For example, the set of design files for above-mentioned frying pan may specify the use of Teflon, or may specify the use of cast-iron. A design file from the set of design files may be selected based on the determined printer capability (e.g., if a printer that is operatively linked with the user equipment is not capable of printing Teflon, but is capable of printing an iron model, the cast-iron version of the frying pan may be selected). A request may be transmitted to the printer to print the three-dimensional representation of the object described by the design file.

Methods and systems are also provided herein for sourcing a design file for three-dimensional printing of an object presented within a video. These methods and systems are provided by receiving a selection of an object, and generating a display including at least one of (1) a first selectable option to submit a first design file describing a first three-dimensional representation of the object, and (2) a second selectable option to access a second design file describing a second three-dimensional representation of the object submitted by another user. For example, if a selection of a frying pan is made, the user may choose to submit the user's own design file that specifies a three-dimensional representation of the frying pan. The user may also choose to access a design file that specifies a three-dimensional representation of the frying pan that was submitted by another user. If the first selectable option is selected, the user's design file may be transmitted to a database for storage. If the second selectable option is selected, the design file that was submitted by another user may be retrieved from the database.

The term “object” wherever used in this disclosure refers to any depiction within a media asset of a discrete item. Any individually recognizable item or component is within the scope of the definition of “object. For example, if a frying pan is depicted, the frying pan as a whole may be the object, and components of the frying pan such as a handle or grip of the frying pan may also be an object.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

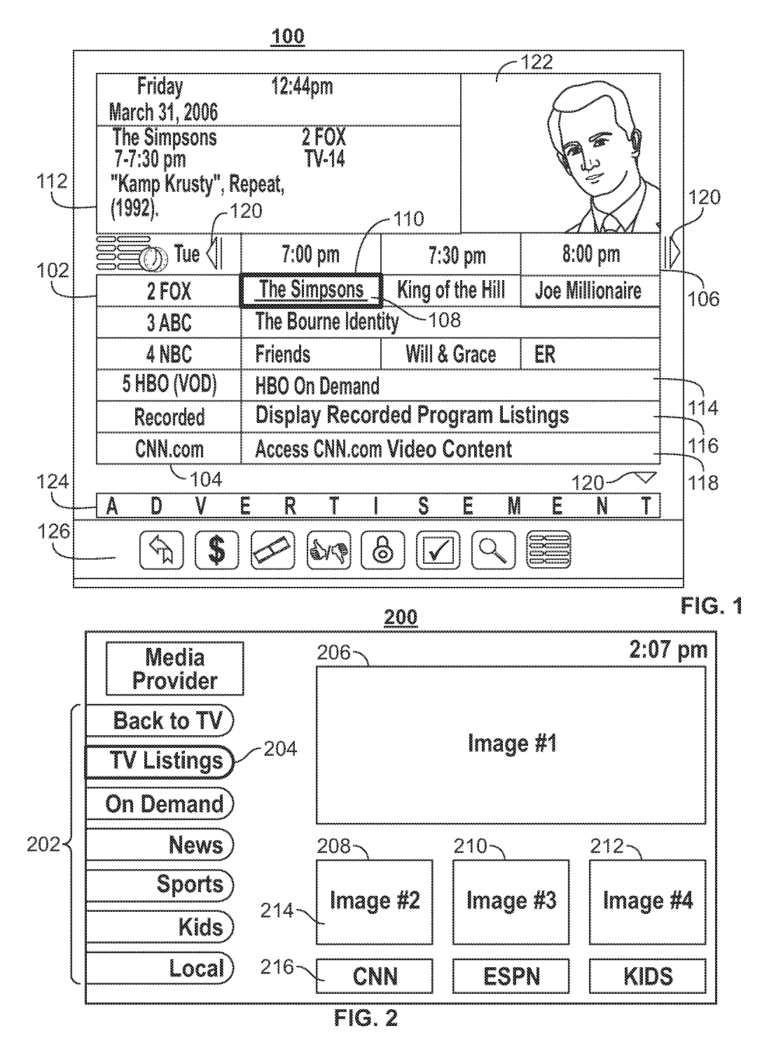

FIGS. 1-2 show illustrative display screens that may be used to provide media guidance data. The display screens shown in FIGS. 1-2 and 5-15 may be implemented on any suitable user equipment device or platform. While the displays of FIGS. 1-2 and 5-15 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

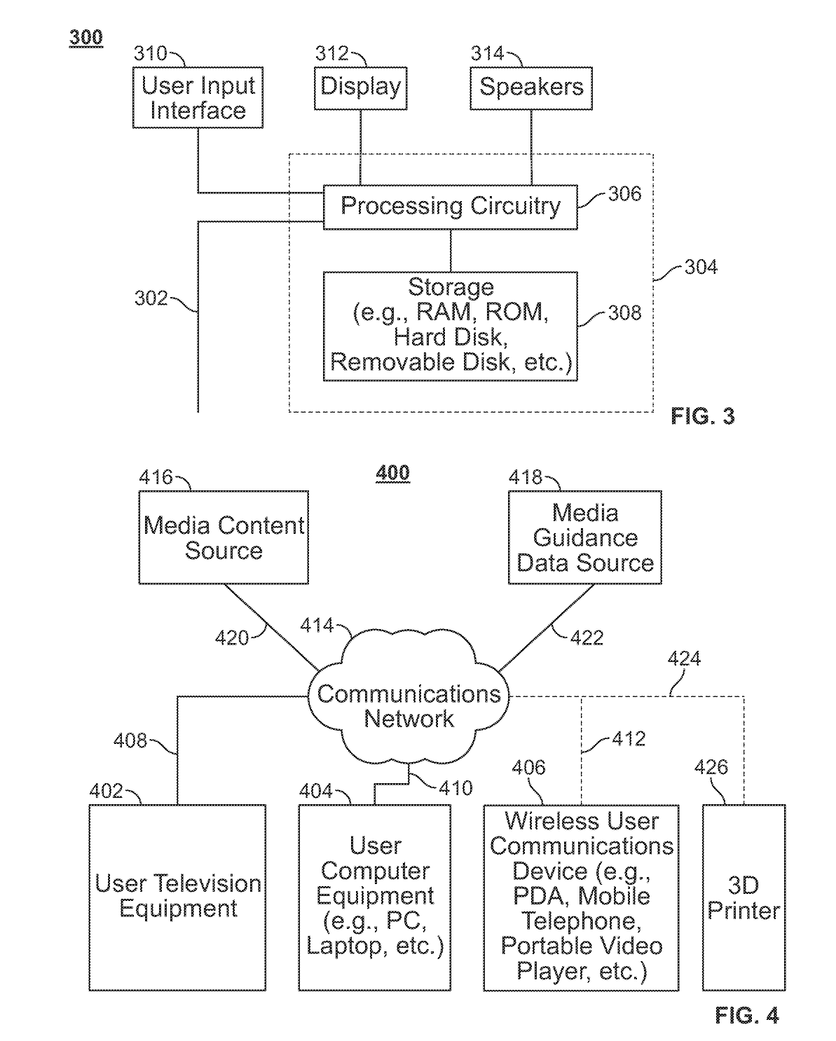

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, 3D printer 426, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below. Various methods and systems for utilizing 3D printers are discussed in, for example, Abeloe, U.S. Pat. No. 8,243,334, filed Jun. 5, 2009, Lai et al., U.S. Patent Publication No. 2008/0260918, filed Apr. 23, 2007, and Jandeska, Jr. et al. U.S. Pat. No. 7,141,207, filed Aug. 30, 2004, which are hereby incorporated by reference herein in their entireties.

A user equipment device utilizing at least some of the system features described above in connection with FIG. 3 may not be classified solely as user television equipment 402, user computer equipment 404, a wireless user communications device 406, or 3D printer 426. 3D printer 426 may be used to achieve the objects of the description above and below. User television equipment 402 may, like some user computer equipment 404 or 426, be Internet-enabled allowing for access to Internet content, while user computer equipment 404 or 426 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, wireless user communications device 406, and 3D printer 426 are coupled to communications network 414 via communications paths 408, 410, 412, and 424 respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, 412, and 424 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408, 410, and 424 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, 412, and 424 as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, 412, and 424. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, 406, and 426 are shown as through communications network 414, in some embodiments, sources 416 and 418 may communicate directly with user equipment devices 402, 404, 406, and 426 via communication paths (not shown) such as those described above in connection with paths 408, 410, 412, and 426.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, wireless user communications device 406, and 3D printer 426. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, a request to print a 3D representation of an object appearing in a media asset may be transmitted to a 3D printer. Control circuitry (e.g., control circuitry 304) may identify a set of objects presented within a video being viewed by a user. Control circuitry 304 may select one object of the set of objects based on a user profile. For example, if a child is watching a video that includes a toy amongst other adult objects, control circuitry 304 may select the object associated with the print request to be the toy. A design file may be retrieved that describes a three-dimensional representation of the object. The design file may be retrieved locally (e.g., from a DVD or BLU-RAY drive), or remotely (e.g., from a remote database). Upon retrieval, a request may be transmitted to a printer (e.g., 3D printer 426) to print the 3D representation of the object.

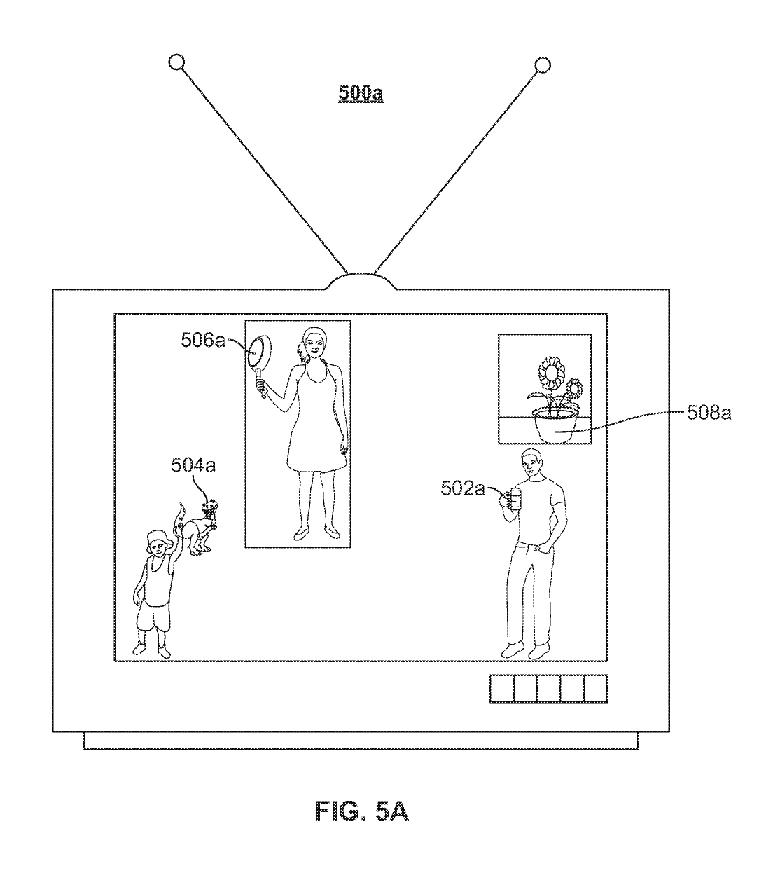

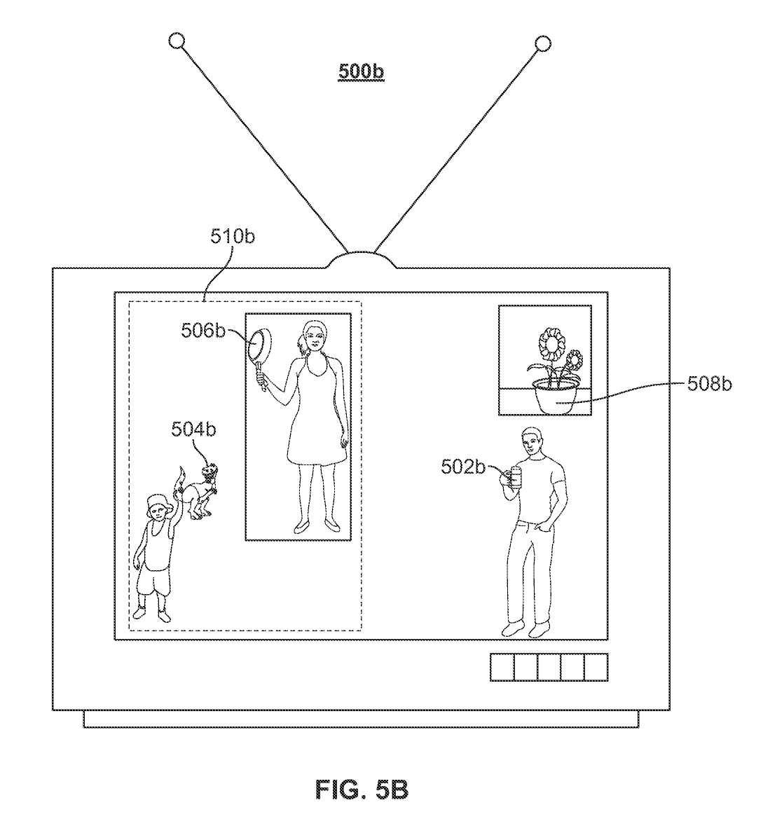

FIG. 5A shows an illustrative embodiment of a user equipment device that may display a video frame including selectable objects available for 3D printing, in accordance with some embodiments of the disclosure. User equipment 500a (e.g., a television) depicts a video that is being viewed by a user. The video may be, for example, broadcast television, Internet video, on-demand video, or video from any other source. Control circuitry 304 may identify a set of objects presented within a video being viewed by a user. The set of objects may be identified by accessing a database such as media guidance data source 418 or media content source 416 via communications network 414. The database may, for example, store data that indicates certain objects that appear in a video frame, a video scene, or a video in its entirety. For example, if an action movie like James Bond is playing, and there a scene with a poker game is playing, media guidance data source may store data indicating that a poker chip object is available in a presently displayed frame or at a present elapsed time. Alternatively, media guidance data source may store data indicating that a poker chip object is available in a presently displayed scene or in a specific window of elapsed time. Alternatively, media guidance data source may store data indicating that a poker chip is an object that appears during the duration of the movie as a whole.

In FIG. 5A, a scene is depicted where a man is holding beer mug 502a, a child is holding toy dinosaur 504a, a woman is holding frying pan 506a, and a flower pot 508a is resting on a window sill. Control circuitry 304a may access a database (e.g., media guidance data source 418) via communications network 414 to determine that each of beer mug 502a, toy dinosaur 504a, frying pan 506a, and flower pot 508a is an object in the presently displayed scene, and may identify each of these objects as part of a set of objects. Control circuitry 304 may select one object of the set of objects based on a user profile. The basis for this selection may be, for example, a determination by control circuitry 304 of which object of the set of objects is most relevant to a user based on a user profile. The user profile may include any or all of a 3D printing history, 3D printing preferences, demographic information, previously viewed media assets, and the like.

In order to make the selection, control circuitry 304 may identify user characteristics associated with a user profile. For example, if Patsy, a forty-year old woman who enjoys watching cooking shows, is watching the presently viewed scene, control circuitry 304 may determine that the user profile reflects user characteristics such as the gender, age, and interests of Patsy. Control circuitry 304 may then determine which object of the set of objects has the greatest number of object characteristics that match the user characteristics associated with the user profile. For example, control circuitry 304 may determine that Patsy is of legal drinking age, and that an object characteristic of the beer mug is that it should be marketed to consumers above the legal drinking age of twenty-one. Control circuitry 304 may determine that toy dinosaur 504a is designed for consumers under the age of 14, so it shares no characteristics with Patsy. Control circuitry 304 may determine that frying pan 506a is associated with people over the age of 16 who are safely capable of cooking, and may determine that Patsy enjoys cooking based on the fact that Patsy enjoys cooking shows. Control circuitry 304 may determine that flower pot 508a is enjoyed by people over the age of 30. Based on the above determinations, control circuitry 304 may designate frying pan 506a as the selected object of the set of objects because it shares two characteristics with Patsy's user profile, which is more than the number of characteristics of any other object in the video frame shared with Patsy's user profile.

In some embodiments, in order to make the selection, control circuitry 304 may consider a capability of a 3D printer (e.g., 3D printer 426) associated with a user profile. For example, if 3D printer 426 includes the capability to print using plastic, but not metal, then frying pan 506a could not be recommended because a design file associated with frying pan 506a may specify metal components. Accordingly, a selection may include that of beer mug 502a or flower pot 508a, and may exclude frying pan 506a. A three-dimensional printer may be associated with one or more capabilities. For example, a three-dimensional printer may only be able to print in certain colors, such as blue or red. As another example, a three-dimensional printer may be able to print utilizing either metal, plastic, or both. A three-dimensional printer may be able to print using soft metals (e.g., gold) but not hard metals (e.g., titanium). Control circuitry 304 may also consider an amount of material remaining as a printer capability. For example, if a design file specifies that one ounce of gold is required to print a three-dimensional representation of a ring, but 3D printer 426 is only equipped with one-half of an ounce of gold, control circuitry 304 may determine that the design file is not viable for printing at 3D printer 426. Any other cost, limitation, material availability, or constraint (e.g, size constraints) associated with 3D printer 426 may be considered by control circuitry 304 as a printer capability.

In some embodiments, a cost associated with printing a 3D object described by a design file describing the 3D object may be considered when selecting one object of the set of objects. For example, a user profile may indicate a past history of only ordering objects that cost five dollars or less to print. Accordingly, simple objects like beer mug 502a or flower pot 508a may be better suited to selection than frying pan 506a, which may require more expensive metal components.

In some embodiments, control circuitry 304 may select one object of the set of objects based on a user profile in a manner described in the foregoing, and then retrieve a design file describing a 3D representation of the object. Control circuitry 304 may retrieve the design file from media guidance data source 418 via communications network 414. Alternatively, control circuitry 304 may retrieve the design file from a local storage 308 such as a hard disk or an optical drive (e.g., a BLU-RAY disc that the movie is being played from).

Control circuitry 304 may transmit a request to a printer (e.g., 3D printer 426) to print the 3D representation of the object. For example, as in the example above, a request may be transmitted to print a 3D representation of frying pan 506a. 3D printer 426 may have the capability to print using plastics, metals, or both, in addition to any other known printing material. 3D printer 426 may print frying pan 506a in one solid piece, or in discrete components that must be automatically or manually assembled. 3D printer 426 may be a printer that is local to user equipment 500, or may be remote from user equipment 500, where the request would travel via communications network 414. 3D printer may have the capability to print edible food. Methods and systems for utilizing 3D printers to print edible food are discussed in, for example, Lai et al., U.S. Patent Publication No. 2008/0260918, filed Apr. 23, 2007, which is hereby incorporated by reference herein in its entirety.

In some embodiments, control circuitry 304 may receive a user selection of an area of a video frame from which an object is to be selected. For example, a user may input a geometric shape around a portion of a video scene (e.g., via user input interface 310). Control circuitry 304 may limit the set of objects to those objects that are within the area of the input geometric shape.

FIG. 5B shows an illustrative embodiment of a user equipment device that may display a video frame including selectable objects available for 3D printing, and may reflect a user selection of objects, in accordance with some embodiments of the disclosure. Control circuitry 304 may receive a user input of geometric shape 510b intended to select a set of objects in a video frame via user input interface 310. Control circuitry 304 may detect input via any known peripheral device, such as a mouse cursor, remote control, or interactive touch screen device that may interact with a stylus or a finger.

A set of contact points of the input device (e.g., the points a stylus or cursor touches during input) may define a perimeter of geometric shape 510b. Control circuitry 304 may determine whether geometric shape 510b includes an object within its area by comparing the coordinates of the contact points against the coordinates of the objects, where when the coordinates of an object are within the area of the contact points, a positive determination may be made.

Control circuitry may identify only objects that are within the area of geometric shape 510b as being part of an identified set of objects presented within a video being viewed by the user, to the exclusion of other objects presented within the video. Control circuitry 304 may perform its selection of one object of the set of objects in any manner described in the foregoing. Control circuitry 304 may then retrieve a design file describing a three-dimensional representation of the selected object, and may transmit a request to a printer to print the three-dimensional representation of the selected object.

In some embodiments, user characteristics of a user's profile may be associated with a user profile at a database (e.g., media guidance data source 418). The user characteristics may be updated by control circuitry 304 in response to certain actions, such as media being consumed or objects being printed. Media guidance data source 418 may also store objects in a scene of a video, such that control circuitry 304 may compare the object characteristics with those of the objects.

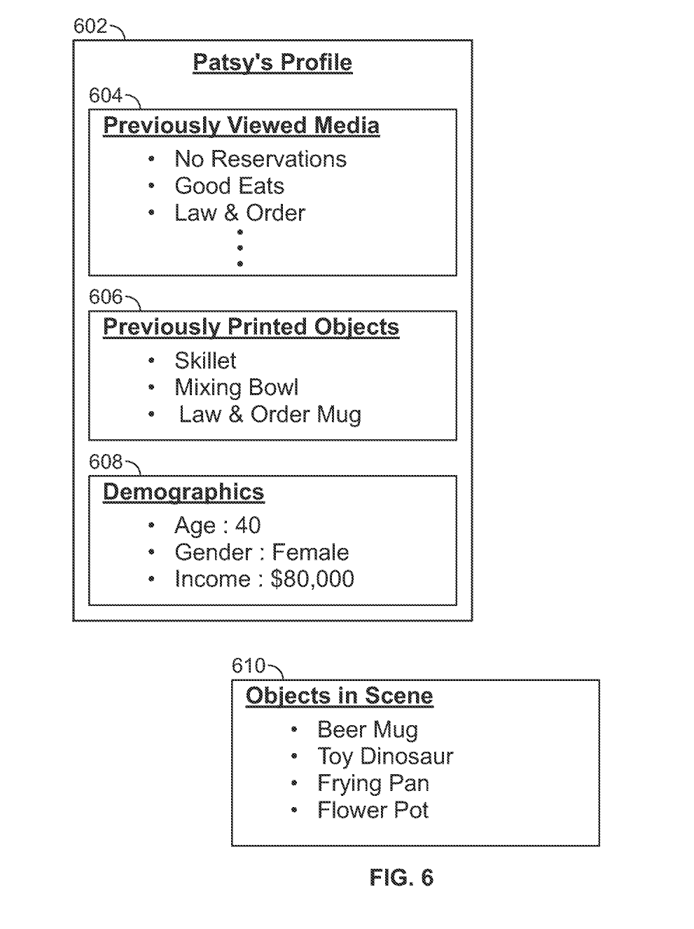

FIG. 6 shows an illustrative embodiment of user characteristics of a user profile, as well as object characteristics of objects in a video frame, in accordance with some embodiments of the disclosure. Database entry 602 may include data associated with Patsy's user profile. Database entry 602 may be stored as a data structure, or as a record in a database. While entry 602 includes previously viewed media 604, previously printed objects 606, and demographics 608, this is merely illustrative and a user profile may include any data associated with or relating to a user, such as credit card purchases, geographical information, user equipment capabilities, capabilities of 3D printer 426, etc. Data entry 602 may be utilized to identify user characteristics associated with the user profile, as discussed in the foregoing.

Previously viewed media 604 may include television shows, such as “No Reservations,” “Good Eats,” “Law and Order,” and any other media that Patsy has previously viewed. Previously printed objects 606 may include a skillet, a mixing bowl, and a “Law and Order” mug, as well as any other objects Patsy has printed. Demographics 608 may reflect any known or guessed demographics of a user, such as age, gender, income, or any other demographic. Control circuitry 304 may utilize user profile 602 to determine which objects of a set of objects to select for printing at 3D printer 426.

Data entry 610 is illustrated to reflect objects in a scene, such as that displayed on user equipment 500a; however, as discussed in the foregoing, data entry 610 may reflect objects based on other factors, such as an elapsed time of a video. Data entry 610 may reflect that objects in a scene include a beer mug (e.g., beer mug 502a), a toy dinosaur (e.g., toy dinosaur 504a), a frying pan (e.g., frying pan 506a), and a flower pot (e.g., flower pot 508a). Though not illustrated, data entry 610 may include detailed object characteristics associated with each object. For example, data entry 610 may reflect that a beer mug object is associated with an age of twenty-one or higher. As another example, data entry 610 may reflect that a toy dinosaur object is associated with plastic, and that a frying pan is associated with a metal, such as iron. These detailed object characteristics may be used for selecting an object for printing (e.g., by determining which object shares the most characteristics with a user profile, as discussed in the foregoing).

In some embodiments, a data entry may be stored at a database (e.g., media guidance data source 418) that describes the capabilities of a 3D printer. Control circuitry 304 may access the database (e.g., via communications network 414) to retrieve the printer capabilities. As described in the foregoing, printer capabilities may be a factor in determining which object of a set of objects to print.

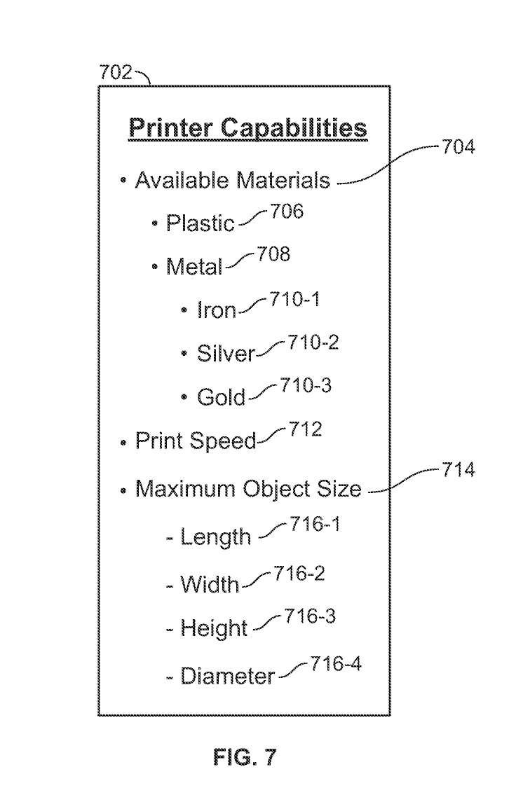

FIG. 7 shows an illustrative embodiment of capabilities of a printer, in accordance with some embodiments of the disclosure. As described in the foregoing, control circuitry 304 may determine which object of a set of objects to transmit a request for printing for based on printer capabilities, such as those described in database entry 702. Database entry 702 may be stored in a data structure, or as a record in a database. Control circuitry 304 may access database entry 702 by querying a database such as media guidance data source 418 via communications network 414. Alternatively, 3D printer 426 may store data entry 702 (e.g., at storage 308), and control circuitry 304 may query 3D printer 426 to learn of 3D printer 426's printing capabilities.

The printer capabilities of FIG. 7 that are depicted in data entry 702 are merely illustrative and are not intended to be comprehensive. Data entry 702 reflects the materials available to 3D printer 426 (e.g., plastic or metal) in item 704. Item 704 may indicate that only one type of plastic 706 is available. Item 704 may indicate that three types of metal 708 are available to 3D printer 426 (e.g., iron 710-1, silver 710-2, and gold 710-3). Item 712 may indicate one or more print speeds of 3D printer 426. Item 714 may indicate a maximum object size of that 3D printer 426 is capable of printing. Any of items 716-1, 716-2, 716-3 may be reflected in item 714 to indicate a maximum size in terms of length, width, height, or diameter of an object.

Control circuitry 304 may compare printer capabilities reflected in data entry 702 to requirements specified by a design file of an object. For example, if a design file for a toy dinosaur specifies that a dinosaur's height is to be 14 inches, and data entry 702 reflects that the maximum height of an object 3D printer 426 is capable of printing is 12 inches, then control circuitry 304 may refrain from selecting the toy dinosaur as an object for which a request will be transmitted to print a three-dimensional representation of.

In some embodiments, a user may wish to configure a three-dimensional representation of an object that is described by a retrieved design file prior to the object being printed. Control circuitry 304 may generate a display including a three-dimensional representation of a selected object, such as a dinosaur. A user may provide user input (e.g., via user input interface 310) to configure the object (e.g., a toy dinosaur). Control circuitry 304 may generate a display including a user interface displayed via display 312 that assists a user in providing user input. In response to receiving user input, control circuitry 304 may cause the three-dimensional representation of the object to be modified. For example, user input may cause the three-dimensional representation of toy dinosaur 504 to be scaled down.

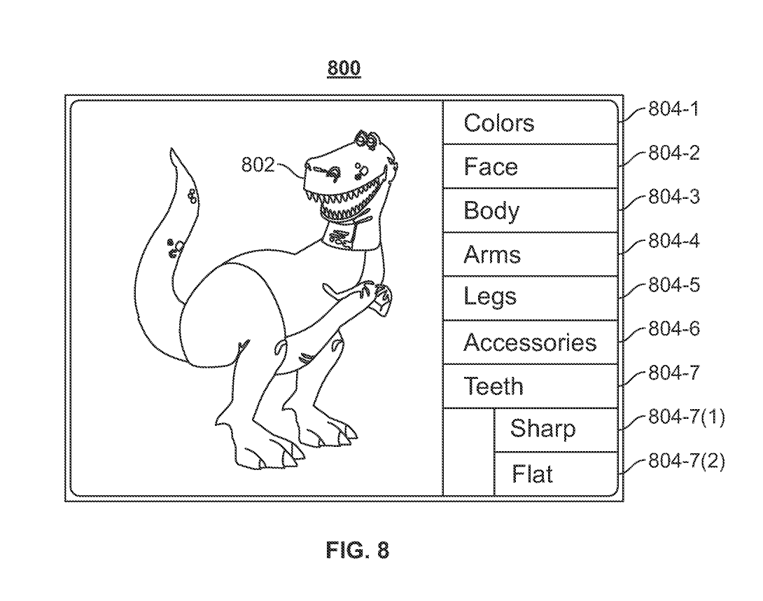

FIG. 8 shows an illustrative embodiment of a user interface for configuring a 3D representation of an object, in accordance with some embodiments of the disclosure. User equipment 800 includes a display of toy dinosaur 802, the display of which is generated by control circuitry 304. Toy dinosaur 802 may have been selected by control circuitry 304 from the set of objects displayed in FIG. 5A in a manner consistent with the foregoing. Control circuitry 304 may generate for display a user interface including selectable icons 804. When control circuitry 304 receives a user selection of a selectable icon, a sub-menu of selectable options may appear. For example, if a user selection is received of teeth icon 804-7, a sub-menu of selectable options 804-7(1) and 804-7(2) may be generated for display by control circuitry 304. Alternatively, available selectable options for each selectable icon 804 may be displayed initially by the user interface. If a user selects a selectable option, such as “sharp” option 804-7(1), control circuitry 304 may add sharp teeth to the displayed 3D representation of dinosaur 802. A print of dinosaur 802 subsequent to this modification may include sharp teeth in the printed 3D representation.

Selectable icons 804 are merely illustrative and are not intended to be limiting. If control circuitry 304 receives a user selection of color icon 804-1, control circuitry 304 may cause some or all of dinosaur 802 to be a user-selected color. The user-selected color may be selected from a sub-menu of selectable options. Similarly, if control circuitry 304 receives a user selection of face icon 804-2, body icon 804-3, arms icon 804-4, or legs icon 804-5, control circuitry may offer a sub-menu of selectable options to a user to, for example, adjust a type or pose of dinosaur 802's arms, legs, or body. If control circuitry 804-6 receives a user selection of selectable icon 804-6, control circuitry 304 may cause a sub-menu of selectable options of accessories for a user to select from. For example, a user may be able to select from adding sunglasses or a hat to dinosaur 802. Control circuitry 304 may cause accessories to be printed as one cohesive unit with a printed 3D representation of an object, such as dinosaur 802, or may cause accessories to be printed separately from the 3D representation of the object. Control circuitry 304 may generate for display to a user an option to print an accessory separately from, or as one cohesive unit with, the printed 3D representation of a printed object.

In some embodiments, control circuitry 304 may generate a display including a video on a first user equipment device (e.g., user television equipment 402) and may receive user input from a second user equipment device (e.g., user equipment 404). The second user equipment device may be a portable device, such a as a tablet computer (e.g., iPad). User input received by control circuitry 304 from the second user equipment device may include any user input described in the foregoing or below, including selection of an object for printing, or user input directing the configuration of an object.

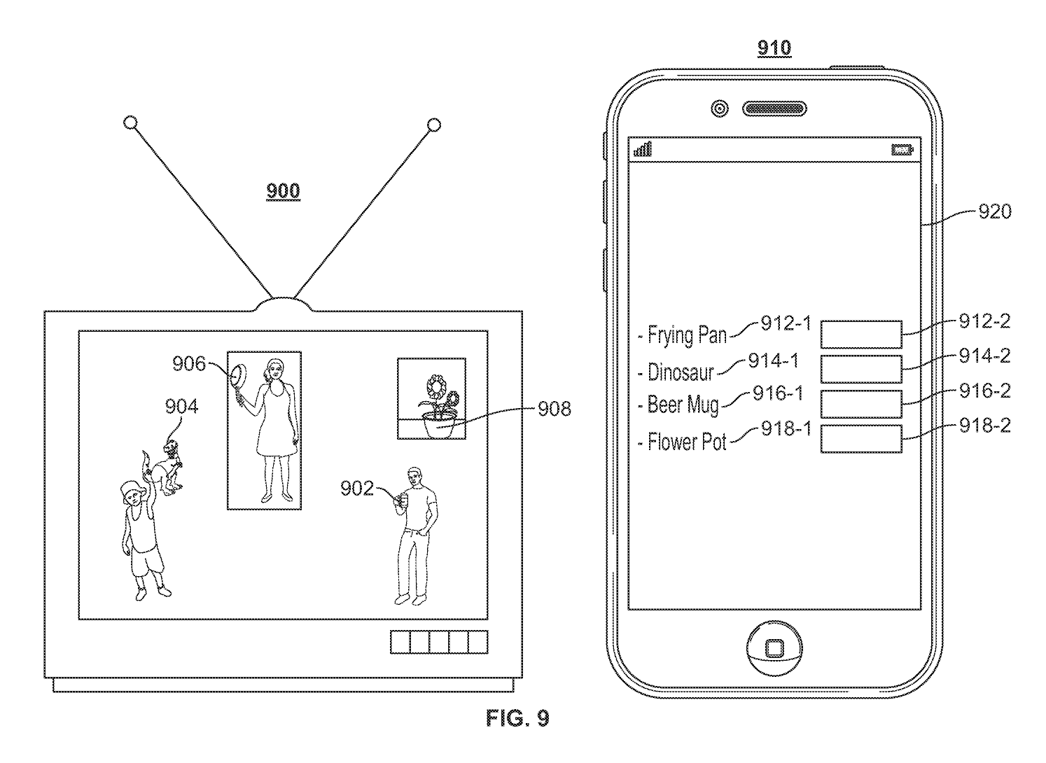

FIG. 9 shows an illustrative embodiment of a first user equipment and a second user equipment device, where the second user equipment device reflects selectable objects of a video frame presented at the first user equipment device, in accordance with some embodiments of the disclosure. User equipment 910 may be a portable electronic device, such as a tablet computer (e.g., iPad). Control circuitry 304 may generate a display including selectable objects 912, 914, 916, and 918. Control circuitry 304 may cause user equipment 910 to selectively display objects of a video from a particular frame, scene, or range of elapsed times, to the exclusion of other objects, based on a user profile in a manner described above with regard to FIG. 5A. Alternatively, control circuitry 304 may cause user equipment 910 to display any or all objects of a video from a particular frame, scene, or range of elapsed times without regard to a user profile.

Display 920 is presented in list form for illustrative purposes only. Display 920 may be generated by control circuitry 304 to present an image that is identical or similar to that displayed in user equipment 900. Display 920 may include a list of object identifiers 912-1, 914-1, 916-1, and 918-1, each of which is adjacent to a selectable icon 912-2, 914-2, 916-2, and 918-2. Selectable icons 912-2, 914-2, 916-2, and 918-2 may be selectable images that depict a representation of the object described by respective object identifiers 912-1, 914-1, 916-1, and 918-1. In some embodiments, object identifiers 912-1, 914-1, 916-1, and 918-1 may themselves be interactive and selectable. In some embodiments, where display 920 depicts an image that is the same or identical to that displayed by user equipment 900, objects that have associated design files may themselves be selectable. For example, a user may be able to select by clicking on or touching frying pan 906 at user equipment 900 via user input interface 310 to instruct control circuitry 304 to retrieve a design file that specifies a 3D representation of frying pan 906. When an object is selected, control circuitry 304 may process the printing of a three-dimensional representation of the object in any manner described in the foregoing.

In some embodiments, control circuitry (e.g., control circuitry 304) may generate for display a selectable option that enables a user to contribute a design file for an object, or to select a user-contributed design file for an object. The display of the selectable options may be generated in response to receipt of a selection of an object by control circuitry 304. For example, if a toy dinosaur is selected in a video frame, an option to contribute a user's own design file that specifies a 3D representation of the toy dinosaur may be generated for display by control circuitry 304. Another option to select a design file that was contributed by a different user may also be generated for display by control circuitry 304.

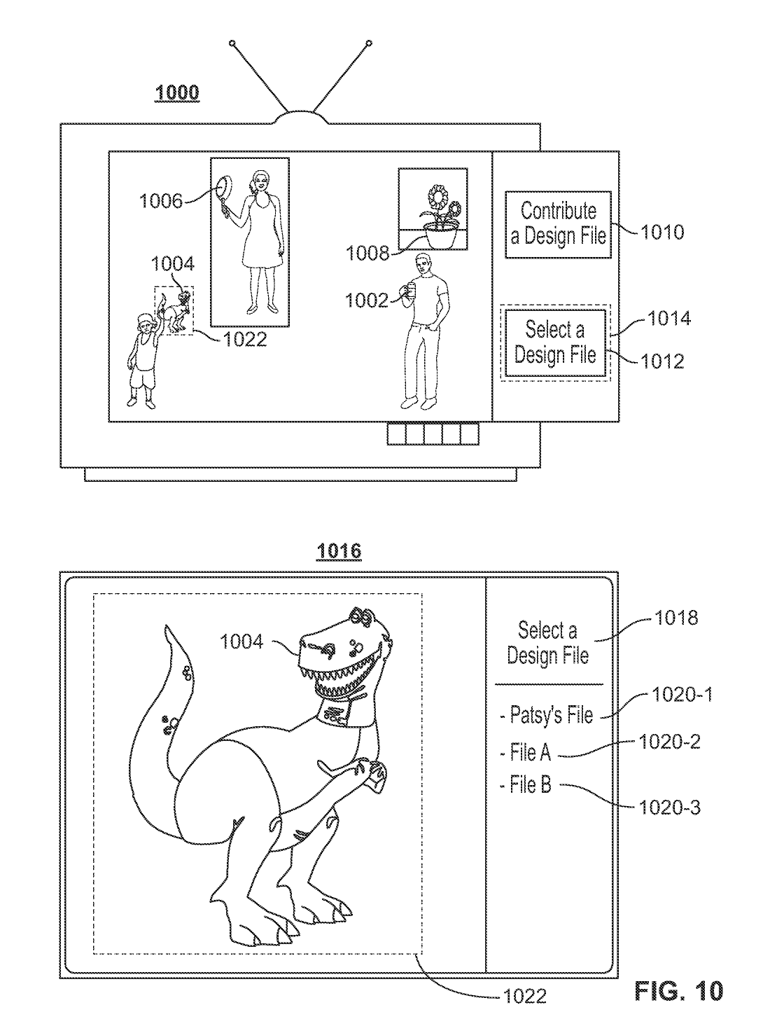

FIG. 10 shows an illustrative embodiment of a menu of selectable options that are presented in response to a user selection of an object, in accordance with some embodiments of the disclosure. Control circuitry 304 may receive a selection of dinosaur 1004. Dinosaur 1004 may be selected manually by control circuitry 304 detecting the user input of geometric shape 1022 in a manner consistent with that described with regard to FIG. 5B. Dinosaur 1004 may be selected automatically by control circuitry 304 in a manner consistent with that described with regard to FIG. 5A, or in any other manner consistent with this specification. When control circuitry 304 receives the selection of dinosaur 1004, control circuitry may generate for display selectable options 1010 and 1012.

When control circuitry 304 receives a user input selecting selectable option 1010, control circuitry 304 may enable a user to enter a virtual location where a design file that the user wishes to submit is stored. Control circuitry 304 may automatically inspect the design file to determine whether the design file in fact reflects the selected object (e.g., by determining a correlation between features of other design files associated with the selected object and comparing it to a threshold correlation). Control circuitry 304 may generate a display including an option to input a price associated with a contributed design file. For example, control circuitry 304 may receive user input that describes a price of five dollars and that describes a bank account for which any purchase proceeds are to be deposited.

When control circuitry 304 receives a user input selecting selectable option 1012, control circuitry may generate display 1016 for display. Display 1016 includes menu 1018 enabling a user to select a user-submitted design file. Menu 1018 may be a list of user-submitted design files. Each item 1020 of the list may be interactive. If an item 1020 is selected, a preview of a design file (e.g., a display of a 3D representation of an object) associated with selected object 1004 may be generated for display by control circuitry 304. A price may be generated for display, either with the preview of the design file, or adjacent to item 1020. The price may be specified by a user as described above, or may be automatically specified.

In some embodiments, control circuitry (e.g., control circuitry 304) may identify a set of objects presented within a video (e.g., via user input or via automatic processing) being viewed by a user. For example, control circuitry 304 may identify all objects in a frame of a video that are associated with design files that specify a 3D representation of an object for printing. Control circuitry 304 may select one object of the set of objects based on a user profile. For example, if a scene in a video contains a baseball, and the viewer has a history of watching baseball games, the baseball may be selected. Control circuitry 304 may retrieve a design file that describes a three-dimensional representation of the object, and may transmit a request to a printer to print the three-dimensional representation of the object.

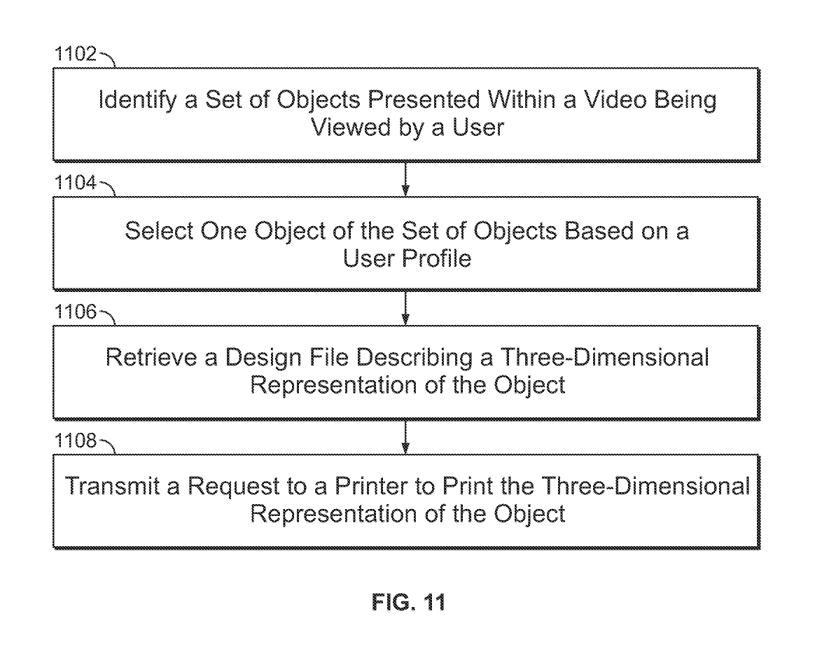

FIG. 11 is a flowchart of illustrative steps taken to select an object of a video being viewed by a user, retrieve a design file describing a 3D representation of the object, and transmitting a request to print the 3D representation, in accordance with some embodiments of the disclosure. In step 1102, control circuitry (e.g., control circuitry 304) may identify a set of objects presented within a video (e.g., beer mug 502a, toy dinosaur 504a, frying pan 506a, and flower pot 508a) being viewed by a user. The set of objects may be identified automatically, or may be identified via user input (e.g., geometric shape 510b). In step 1104, control circuitry 304 may select one object of the set of objects based on a user profile. For example, if the user is Patsy, as described with regard to FIG. 7, frying pan 506a may be selected by control circuitry 304 because of Patsy's interest in cooking television shows.

In step 1106, control circuitry 304 may retrieve a design file describing a three-dimensional representation of the object. For example, the design file may specify any object characteristic associated with a three-dimensional representation of the object for printing, such as (but not limited to) height, width, length, materials (e.g., plastic, metal, etc.), cost, color, and the like. In step 1108, control circuitry 304 may transmit a request to a printer to print the three-dimensional representation of the object in accordance with the specifications of the design file. For example, if the design file specifies a 3D representation of frying pan 506a is to be cast iron, ten inches in diameter, and to have a steel handle that is five inches long that is to be printed as a separate component, control circuitry 304 may send consistent instructions to 3D printer 426 to print a 3D representation of frying pan 506a that satisfies those specifications.

In some embodiments, control circuitry (e.g., control circuitry 304) may make a determination of which object of a set of objects in a video being viewed by a user is most relevant to the user. Control circuitry 304 may identify user characteristics associated with a user profile (e.g., previously viewed media assets, or printer capabilities), and determine which object of the set of objects has a greatest number of object characteristics that match the user characteristics associated with the user profile. For example, control circuitry 304 may determine that beer mug 502a is associated with characteristics such as an age of twenty-one or higher and football, and may determine that a user profile reflects an age of thirty-five and a viewing history of watching football, and may therefore determine beer mug 502a shares more characteristics with the user profile than other objects in a video. Control circuitry may utilize 602, 610, or 702 to make such a determination. Control circuitry 304 may designate

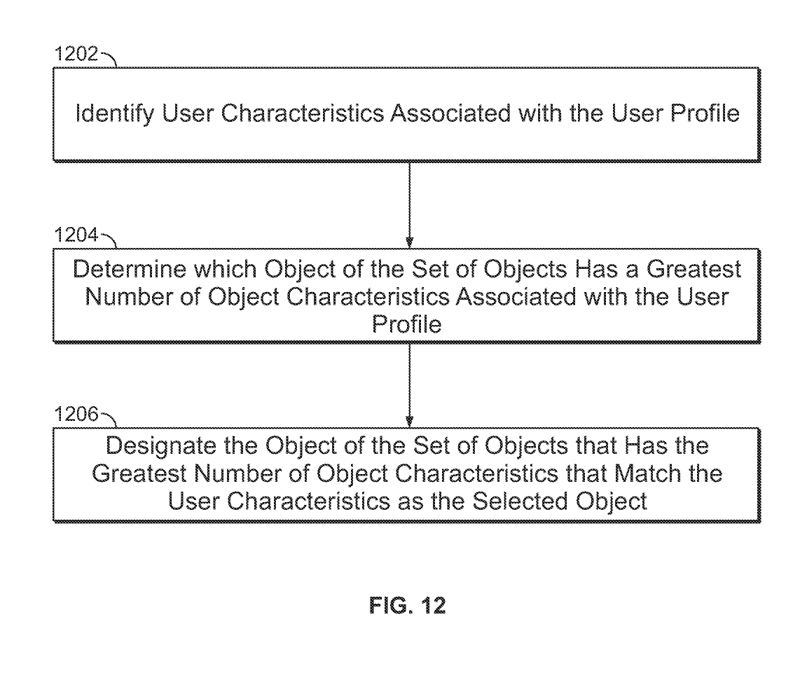

FIG. 12 is a flowchart of illustrative steps taken to determine an object of a set of objects that shares the most characteristics associated with a user profile, in accordance with some embodiments of the disclosure. FIG. 12 may represent steps involved in executing step 1104 of FIG. 11. In step 1202, control circuitry 304 may identify user characteristics associated with a user profile. Identified user characteristics may include any characteristic associated with the user profile, such as previously viewed television shows or printer capabilities (e.g., capabilities of 3D printer 426). Control circuitry 304 may identify the user characteristics associated with the user profile by accessing a database (e.g., media guidance data source 418) and consulting data entries 602 and 702.

In step 1204, control circuitry 304 may determine which objects of a set of objects (e.g., objects 502a, 504a, 506a, and 508a) shares the most characteristics with the identified user characteristics associated with the user profile. For example, control circuitry 304 may compare object characteristics associated with frying pan 506a (e.g., used for cooking, associated with adults) as described in data entry 610 with user characteristics of Patsy's profile as reflected in data entry 602 (e.g., previously watched food snows, previously printed cooking utensils, over the age of 40). Control circuitry 304 may compare object characteristics associated with other objects, such as beer mug 502a (e.g., associated with users who are twenty-one or older) with Patsy's profile as reflected in data entry 602, and may determine that fewer characteristics of beer mug 502a are shared with Patsy's profile than the amount of characteristics of frying pan 506a.

In step 1206, control circuitry 304 may designate the object of the set of objects that has a greatest number of object characteristics that match the user characteristics associated with the user profile as the selected object. As described with regard to FIG. 11, the selected object may form the basis for a request to print a three-dimensional representation of an object (e.g., by following steps 1104 and 1106 of FIG. 11).

In some embodiments, control circuitry (e.g., control circuitry 304) may enable a user to configure a three-dimensional representation of a selected object described by a design file, such that the user can print the configured version. Control circuitry 304 may generate for display the three-dimensional representation of the object (e.g., via display 312). Control circuitry 304 may receive a user input to configure the three-dimensional representation of the object (e.g., via user input interface 310). Control circuitry 312 may transmit a new request to the printer to print the configured three-dimensional representation of the object. The request may be sent via communications network 414.

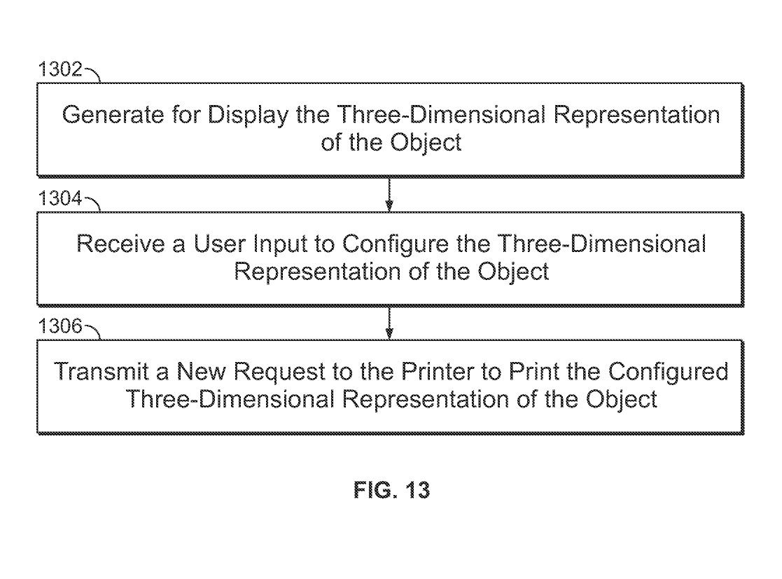

FIG. 13 is a flow chart of illustrative steps involved in receiving user input to configure a 3D representation of an object, and transmitting a request to print the configured 3D representation of the object, in accordance with some embodiments of the disclosure. In step 1302, control circuitry 304 may generate for display the three-dimensional representation of an object. The object may be a selected object that is selected either by control circuitry 304 either automatically or in response to manual user input in any manner described in the foregoing with respect to FIGS. 5A, 5B, 11, and 12. The three-dimensional representation of the object may be displayed along with a user interface, such as the interface displayed in user equipment 800. The interface may display selectable icons and selectable options 804.

In step 1304, control circuitry 304 may receive a user input (e.g., via user input interface 312) to configure the three-dimensional representation of the object. The manner in which the user input may be received may be any manner consistent with the disclosure above with respect to FIG. 8. For example, control circuitry 304 may receive a user input to add a prop (e.g., selected from accessories 804-6) to (or delete a prop or other feature from), or change a pose of (e.g., selected from arms 804-4), a 3D representation of the object. In step 1306, control circuitry 304 may transmit a new request to 3D printer 426 to print the configured 3D representation of the object. The new request may be transmitted via communications network 414. As described in the foregoing, 3D printer 426 may be local or remote to a user equipment utilized to input the user input.

In some embodiments, to enable the configuration of a 3D representation of an object by a user, control circuitry 304 may generate a display including a user interface that provides tools to modify the three-dimensional representation of the object. Control circuitry 304 may, in response to receiving user input, modify the three-dimensional representation of the object (e.g., by adjusting a pose of or adding a prop to or deleting a feature from the three-dimensional representation of the object). The 3D representation of the object may be displayed via display 312.

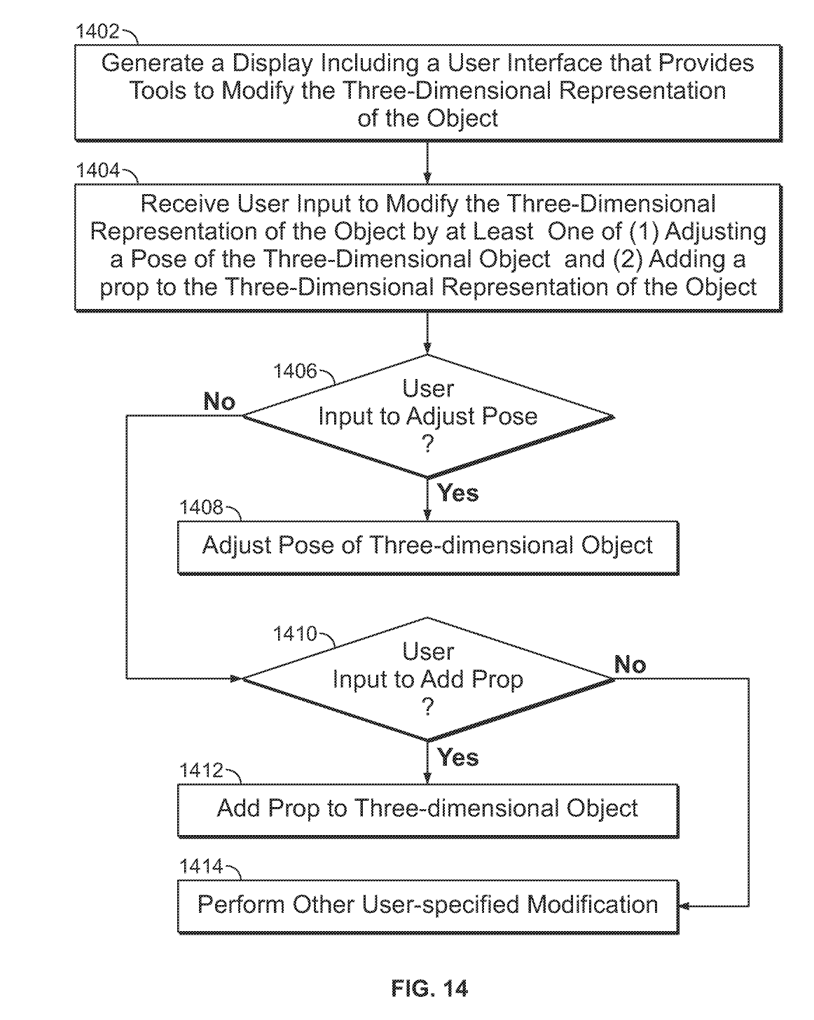

FIG. 14 is a flow chart of illustrative steps involved in providing a user interface for modifying a 3D representation of an object, and either adjusting a pose of or adding a prop to the three-dimensional representation of the object, in accordance with some embodiments of the disclosure. In step 1402, control circuitry 304 may generate a display (e.g., to be presented via display 312) including a user interface that provides tools to modify the three-dimensional representation of an object, such as an object selected during the steps of any of FIGS. 11-13.

The tools provided by the user interface may include tools to modify certain features of a displayed three-dimensional representation. For example, the display may be that displayed by user equipment 800, where control circuitry 304 may receive selection of any of selectable options 804, and responsively modify the displayed 3D representation of toy dinosaur 802. For example, if control circuitry 304 receives a selection of teeth option 804-7, control circuitry 304 may subsequently receive a selection of sharp option 804-7(1) and responsively cause toy dinosaur 802 to be displayed with sharp teeth. Step 1404 describes control circuitry 304 receiving user input to modify the three-dimensional representation of the object by, e.g., adjusting a pose of or adding a prop to the three-dimensional representation of the object or deleting a feature from the three-dimensional representation of the object. As described in the foregoing, a pose may be modified by control circuitry 304 detecting user selection of arms option 804-4, and a prop may be added by control circuitry 304 detecting user selection of accessories option 804-6.

In step 1406, control circuitry 304 may determine whether the user input in to adjust a pose. If the user input was to adjust a pose, step 1408 will be executed, and the pose of the three-dimensional object will be adjusted. If the user input was not to adjust a pose, control circuitry 304 may determine in step 1410 whether the user input was to add a prop to the three-dimensional object. If the user input was to add a prop to the three-dimensional object, control circuitry 304 may execute step 1412 and add a prop to the three-dimensional object. If the user input was not to add a prop to the three-dimensional object, control circuitry 304 may execute step 1414 and perform any other user-specified modification.

In some embodiments, control circuitry (e.g., control circuitry 304) may determine a printer capability associated with a user equipment. Control circuitry may select or receive a selection of an object in a video, and identify a set of design files associated with the object. For example, control circuitry 304 may receive a selection of frying pan 506a, and identify a set of four design files associated with frying pan 506a. Control circuitry 304 may select a design file from the set of design files based on the determined printer capability. For example, if a 3D printer (e.g., 3D printer 426) is only capable of printing using iron (as may be determined by querying data entry 702), a design file from the set of design files that specifies the use of only iron may be selected. Control circuitry 304 may transmit a request to a printer to print a 3D representation of the object described by the selected design file (e.g., via communications network 414).

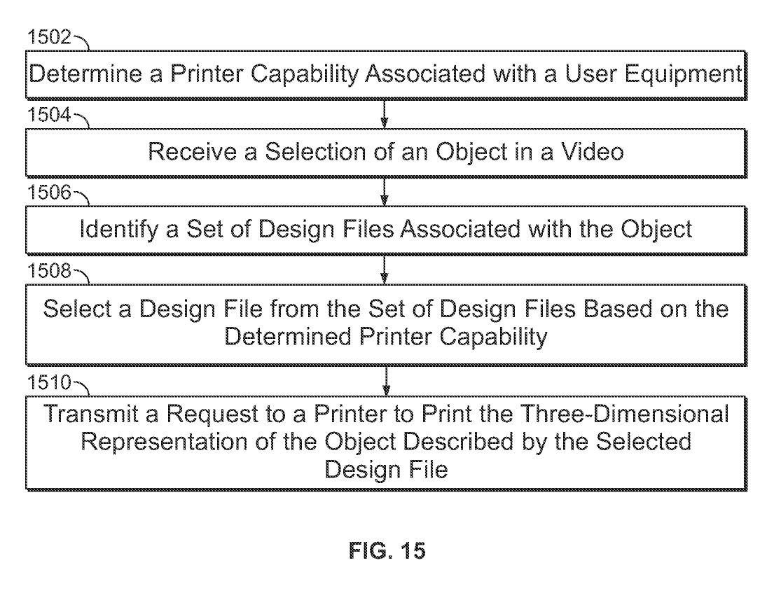

FIG. 15 is a flow chart of illustrative steps involved in selecting a design file from a set of design files associated with an object in a video based on a printer capability associated with a user equipment, and transmitting a request to a printer to print a 3D representation of an object described by the selected design file, in accordance with some embodiments of the disclosure. In step 1502, control circuitry 304 may determine a printer capability (e.g., printer capabilities of 3D printer 426) associated with a user equipment (e.g., user equipment 404). The printer capability may be determined by using user profile information. To determine the printer capability, control circuitry 304 may query a database (e.g., media guidance data source 418), and may receive a response from the database based on information in data entries 602 or 702.

In step 1504, control circuitry 304 may receive a selection of an object in a video. The selection may be made automatically (e.g., based on user profile information as discussed with regard to FIG. 5A) or in response to user input (e.g., the input of geometric shape 510 as discussed with regard to FIG. 5B). In step 1506, control circuitry 304 may identify a set of design files associated with the selected object. The design files may be identified by querying a database, such as media guidance data source 418. The design files may be identified by determining whether a design file associated with a selected object is stored locally (e.g., at storage 308).

In step 1508, control circuitry 304 may select a design file from the set of design files based on the determined printer capability. For example, control circuitry 304 may assess whether a design file shares a printing capability (e.g., that 3D printer 426 can only print using iron), and select a design file accordingly (e.g., a design file that utilizes only iron may be selected). In step 1510, control circuitry 304 may transmit a request to a printer (e.g., 3D printer 426) to print a three-dimensional representation of the object described by the selected design file. For example, if the design file specifies a three-dimensional representation of frying pan 506a that is to be printed using cast iron, 3D printer 426 may print a 3D representation of frying pan 506a following the specification of the design file in response to the request.

In some embodiments, control circuitry (e.g., control circuitry 304) may identify a required printing capability for each design file of the set of design files. This identification may be performed by querying a database (e.g., media guidance data source 418) for information associated with each design file. Control circuitry 304 may compare the identified required capability of each design file of the set of design files to the printing capability of a printer (e.g., 3D printer 426), and may select a design file based on a result of the comparing. For example, if 3D printer 426 is only capable of printing using yellow or blue plastic, control circuitry 304 may select a design file that specifies printing utilizing blue plastic.

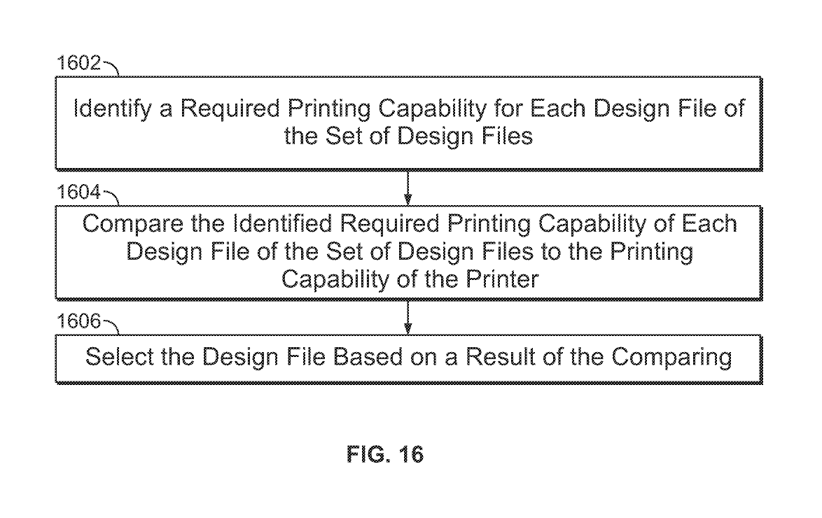

FIG. 16 is a flow chart of illustrative steps involved in selecting a design file associated with an object based on the printing capabilities required by each design file of a set of design files, and based on the capabilities of a printer, in accordance with some embodiments of the invention. FIG. 16 may represent steps involved in step 1508 of FIG. 15. In step 1602, control circuitry 304 may identify a required printing capability for each design file of the set of design files. Control circuitry 304 may perform this identification by querying a database, such as media guidance data source 418. Control circuitry 304 may learn the required printing capability by accessing data file 610, which may be stored at the database.

In step 1604, control circuitry 304 may compare the identified required printing capability of each design file of the set of design files to the printing capability of the printer. Control circuitry 304 may learn the printing capability of a 3D printer (e.g., 3D printer 426) by querying a database (e.g., media guidance data source 418) for information relating to data entry 702, which may be stored at the database. Control circuitry 304 may perform the comparison by comparing each required capability of a design file of the set of design files is a capability that 3D printer 426 has by consulting data entry 702. In step 1604, control circuitry 304 may select the design file based on a result of the comparing. For example, if 3D printer 426 is capable of printing only in the color blue, a design file may be selected if it only requires a blue color.

In some embodiments, control circuitry (e.g., control circuitry 304) may enable a user to, in response to control circuitry 304 receiving a user selection of an object, either select a design file describing a 3D representation of the object or submit a design file describing a 3D representation of the object. When control circuitry 304 receives a user input (e.g., via user input interface 310) indicating that the user would like to submit a design file, control circuitry 304 may transmit a design file to a database (e.g., media guidance data source 418) for storage. When control circuitry 304 receives a user input indicating that the user would like to select a design file, control circuitry 304 may retrieve the second design file from the database.

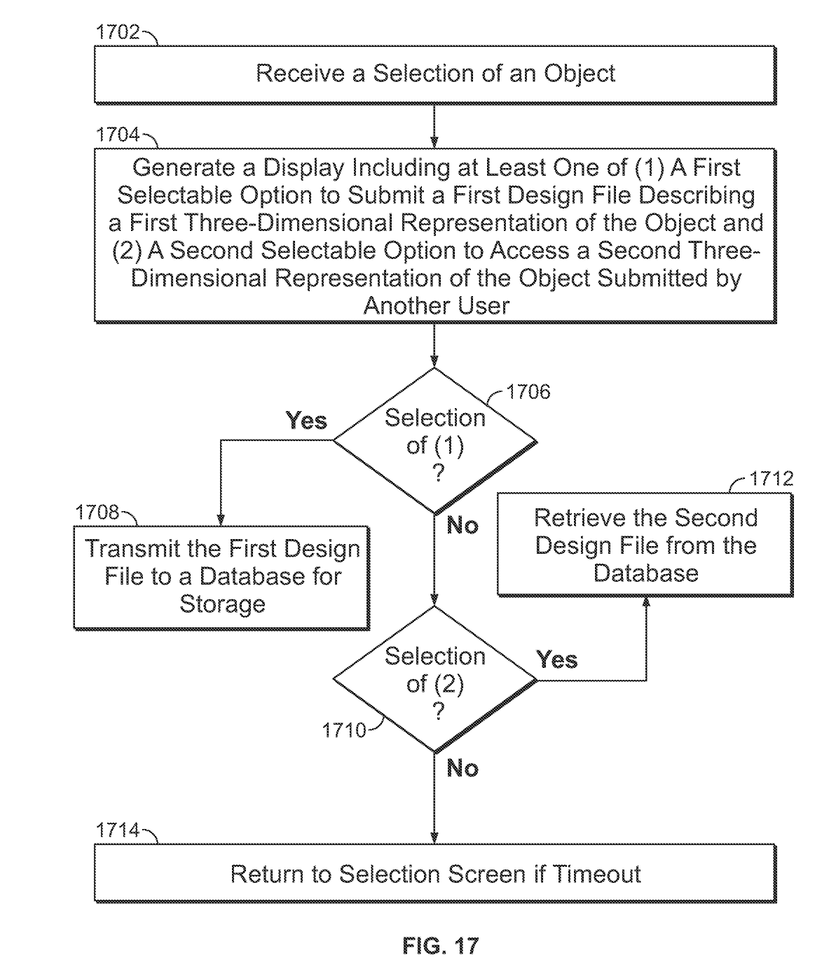

FIG. 17 is a flow chart of illustrative steps involved in allowing a user to contribute a design file associated with a selected object, or choose a user-contributed design file associated with the selected object, when a user wishes to print a 3D representation of the selected object, in accordance with some embodiments of the disclosure. In step 1702, control circuitry 304 may receive a selection of an object. The selection may be received via any manner discussed in FIG. 5A or 5B (e.g., based on user profile information, and/or input of geometric shape 510b).

In step 1704, control circuitry 304 may generate a display including at least one of (1) a first selectable option to submit a first design file describing a first three-dimensional representation of the object and (2) a second selectable option to access a second three-dimensional representation of the object submitted by another user. The first selectable option may be selectable option 1010. The second selectable option may be selectable option 1012.

In step 1706, control circuitry 304 may determine whether the first selectable option was selected. This determination may be made by control circuitry 304 determining whether user input was received via user input interface 312 to select the first selectable option. If control circuitry 304 determines that the first selectable option was selected, control circuitry 304 may execute step 1708 and transmit the first design file to a database (e.g., transmit via communications network 414 to media guidance data source 418) for storage. If control circuitry 304 determines that the first selectable option was not selected, control circuitry 304 may execute step 1710.

In step 1710, control circuitry 304 may determine whether the second selectable option was selected. This determination may be made by control circuitry 304 determining whether user input was received via user input interface 312 to select the second selectable option. If control circuitry 304 determines that the second selectable option was selected, control circuitry 304 may execute step 1712 and retrieve the second design file from a database (e.g., query media guidance data source 418 via communications network 414). If control circuitry 304 determines that the second selectable option was not selected, and a timeout period passes, control circuitry 304 may execute step 1714, which may return the user to a selection screen as described in step 1714.

In some embodiments, control circuitry (e.g., control circuitry 304) may, subsequent to receiving a selection of an object (e.g., frying pan 506a), receive a selection of a selectable option. Control circuitry 304 may responsively transmit a request to a printer (e.g., 3D printer 426) to print a three-dimensional representation of the object based on the specifications of a retrieved design file.

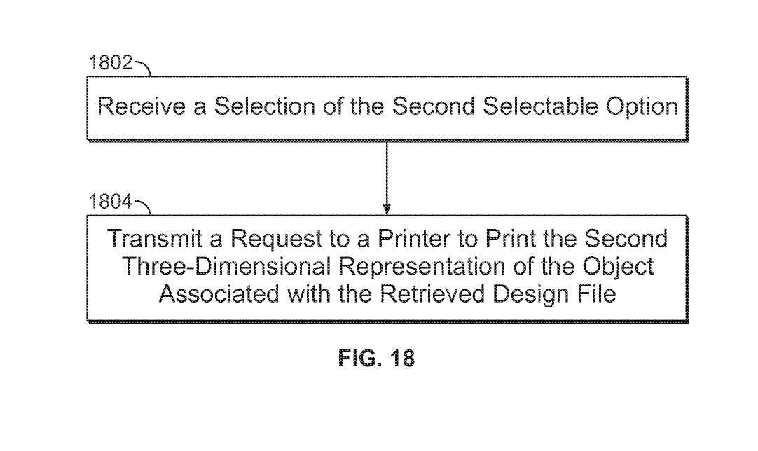

FIG. 18 is a flow chart of illustrative steps taken to transmit a request to a printer to print a 3D representation of a selected object that is described by a selected user-submitted design file, in accordance with some embodiments of the disclosure. FIG. 18 may comprise steps that cause an object selected in step 1702 to be printed. In step 1802, a selection of a second selectable option is received by control circuitry 304. Control circuitry 304 may receive the selection by user input via user input interface 312, or may receive the selection based on an automatic selection based on a user profile.

In step 1804, control circuitry 304 may transmit a request to a printer (e.g., 3D printer 426) to print a 3D representation of an object associated with the retrieved design file. Step 1804 may follow from step 1712 of FIG. 17, where the object is the object selected in step 1702. 3D printer 426 may print a 3D representation of the object.

It will be apparent to those of ordinary skill in the art that methods involved in the present invention may be embodied in a computer program product that includes a computer usable and/or readable medium. For example, such a computer usable medium may consist of a read-only memory device, such as a CD-ROM disk or conventional ROM devices, or a random access memory, such as a hard drive device or a computer diskette, having a computer readable program code stored thereon. A computer usable medium may be a transitory medium (e.g., a carrier wave or signal) or a non-transitory medium (e.g., a hard drive device). It should also be understood, that methods, techniques, and processes involved in the present invention may be executed using processing circuitry. For instance, identifying user characteristics associated with a user profile as described herein may be performed by processing circuitry, e.g., by processing circuitry 306 of FIG. 3. The processing circuitry, for instance, may be a general purpose processor, a customized integrated circuit (e.g., an ASIC), or a field-programmable gate array (FPGA) within user equipment 108 or one of servers 122 of FIG. 1. For example, the user profile information as described herein may be stored in, and retrieved from, storage 308 of FIG. 3, or media guidance data source 418 of FIG. 4. Furthermore, processing circuitry, or a computer program, may update settings associated with a user equipment, such as 3D printer capabilities, updating the information stored within storage 308 of FIG. 3 or media guidance data source 418 of FIG. 4.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes.

1. A method for recommending an object of a plurality of objects for three-dimensional printing, the method comprising:
identifying a set of objects presented within a video being viewed by a user;
selecting one object of the set of objects based on a user profile;
retrieving a design file describing a three-dimensional representation of the object; and
transmitting a request to a printer to print the three-dimensional representation of the object.

2. The method of claim 1, wherein the selecting further comprises:
identifying user characteristics associated with the user profile;
determining which object of the set of objects has a greatest number of object characteristics that match the user characteristics associated with the user profile; and
designating the object of the set of objects that has the greatest number of object characteristics that match the user characteristics as the selected one object of the set of objects.

3. The method of claim 1, wherein the user profile includes at least one of a printing history, printing preferences, and demographic information, and wherein the selecting one object of the set of objects comprises comparing metadata associated with each object with metadata of the user profile.

4. The method of claim 1, wherein the retrieved design file is selected based on a cost associated with printing the three-dimensional object described by the retrieved design file.

5. The method of claim 4, wherein the cost associated with printing the three-dimensional object described by the retrieved design file is associated with the cost of materials required to print the three dimensional representation of the object.

6. The method of claim 1, further comprising:
generating for display the three-dimensional representation of the object;
receiving user input to configure the
three-dimensional representation of the object; and transmitting a new request to the printer to print the configured three-dimensional representation of the object.

7. The method of claim 1, further comprising:
generating a display including a user
interface that provides tools to modify the three
dimensional representation of the object, wherein the
user input is received via the user interface; and in response to receiving the user input, modifying the three-dimensional representation of the object by at least one of (1) adjusting a pose of the three-dimensional representation of the object, (2) adding a prop to the three-dimensional representation of the object, and (3) deleting a feature from the three-dimensional representation of the object.

8. The method of claim 1, wherein the request is transmitted to a remote server at a network that is remote to the user equipment, and wherein the printer is located at the network that is remote to the user equipment.

9. The method of claim 1, wherein the printer is located at a local network, and wherein the user equipment is located at the local network.

10. The method of claim 1, wherein a three-dimensional product is printed by the printer, and wherein the product is edible food.

11. A system for recommending an object of a plurality of objects for three-dimensional printing, the system comprising a processor configured to: identify a set of objects presented 5 within a video being viewed by a user;
select one object of the set of objects based on a user profile;
retrieve a design file describing a
three-dimensional representation of the object; and
transmit a request to a printer to print the three-dimensional representation of the object.

12. The system of claim 11, wherein the selecting further comprises:
identify user characteristics associated with the user profile;
determine which object of the set of
objects has a greatest number of object characteristics that match the user characteristics associated with the user profile; and
designate the object of the set of objects that has the greatest number of object characteristics that match the user characteristics as the selected one object of the set of objects.

13. The system of claim 11, wherein the user profile includes at least one of a printing history, printing preferences, and demographic information, and wherein the selecting one object of the set of objects comprises comparing metadata associated with each object with metadata of the user profile.

14. The system of claim 11, wherein the retrieved design file is selected based on a cost associated with printing the three-dimensional object described by the retrieved design file.

15. The system of claim 14, wherein the cost associated with printing the three-dimensional object described by the retrieved design file is associated with the cost of materials required to print the three-dimensional representation of the object.

16. The system of claim 11, wherein the processor is further configured to:
generate for display the three-dimensional representation of the object;
receive user input to configure the
three-dimensional representation of the object; and transmit a new request to the printer to print the configured three-dimensional representation of the object.

17. The system of claim 11, wherein the processor is further configured to:
generate a display including a user interface that provides tools to modify the three-dimensional representation of the object, wherein the user input is received via the user interface; and
in response to receiving the user input, modify the three-dimensional representation of the object by at least one of (1) adjusting a pose of the three-dimensional representation of the object, (2) adding a prop to the three-dimensional representation of the object, and (3) deleting a feature from the three-dimensional representation of the object.

18. The system of claim 11, wherein the request is transmitted to a remote server at a network that is remote to the user equipment, and wherein the printer is located at the network that is remote to the user equipment.

19. The system of claim 11, wherein the printer is located at a local network, and wherein the user equipment is located at the local network.

20. The system of claim 11, wherein a three-dimensional product is printed by the printer, and wherein the product is edible food.

21-60. (canceled)
